(19) United States
(12) Patent Application Publication
(10) Pub. No.: US 2017/0313418 A1
(43) Pub. Date: Nov. 2, 2017

(54) UNMANNED VEHICLE

(71) Applicant: Hanwha Techwin Co., Ltd., Changwon-si (KR)

(72) Inventor: Seok Hoon YOON, Changwon-si (KR)

(73) Assignee: Hanwha Techwin Co., Ltd., Changwon-si (KR)

(21) Appl. No.: 15/517,798

(22) PCT Filed: Jan. 14, 2015
(86) PCT No.: PCT/KR2015/000363

§ 371 Date: Apr. 7, 2017

(30) Foreign Application Priority Data
Oct. 8, 2014 (KR) 10-2014-0136155

(51) Int. Cl. B64C 39/02; B64C 27/08; B64C 27/20; B64C 27/32

(52) U.S. Cl. CPC B64C 39/024; B64C 27/32; B64C 27/08; B64C 27/20; B64C 2201/027

(57) ABSTRACT

An unmanned vehicle is provided. The unmanned vehicle includes: a base; a driving unit including an actuator and a propeller rotating by using power of the actuator, the driving unit being provided outside the base capable of pivoting with respect to the base; and a supporter protruding from the base and supporting the base.

### TECHNICAL FIELD

The inventive concept relates to an unmanned vehicle.

### BACKGROUND ART

An unmanned aerial vehicle (UAV) is a vehicle that may perform a designated mission without a pilot. The UAV may be remotely controlled or may fly based on a program set in advance or an automation system.

The UAV may mount a vertical takeoff and landing (VTOL) function by generating all of horizontal driving force and vertical driving force. A propeller or a rotor may lift a vehicle by generating the vertical driving force, and move the vehicle forward by generating the horizontal driving force. Since the UAV does not require taxiing by mounting a VTOL function, the UAV may easily perform an operation.

The UAV may be used for a military purpose or a reconnaissance purpose and may collect information by reconnoitering an enemy or exploring the terrain. Also, the UAV may perform ground operations in the terrain which is difficult to penetrate in cooperation with a mobile robot.

Also, the UAV may be used for an industrial purpose to survey land or spray agricultural pesticides. Also, the UAV may be swiftly put into an emergency situation based on a position tracking function and may save victims and survivors under the emergence situation.

### DETAILED DESCRIPTION OF THE INVENTION

### Technical Problem

As aeronautical technology or communication technology develops, the demand for an unmanned aerial vehicle (UAV) increases and a range to which the UAV is applicable gradually expands. Therefore, researches into miniaturization and weight reduction technologies for an UAV are being continuously conducted.

Korean Patent Publication No. 2013-0100566 (titled “unmanned vehicle”) specifically discloses an unmanned vehicle that may fly along a general flying path input in advance.

### Technical Solution

Embodiments of the inventive concept provide an unmanned vehicle that may fold a driving unit generating driving force.

According to an aspect of the inventive concept, there is provided an unmanned vehicle including: a base; a driving unit including an actuator and a propeller rotating by using power of the actuator, the driving unit being provided outside the base capable of pivoting with respect to the base; and a supporter protruding from the base and supporting the base.

### Advantageous Effects of the Invention

Embodiments of the inventive concept may minimize a size of an unmanned vehicle by folding a driving unit generating driving force. Also, since when the driving unit is inserted between supporters supporting the unmanned vehicle, a propeller is arranged in an inner space of the unmanned vehicle, durability of the unmanned vehicle is improved and the unmanned vehicle may be easily stored. The scope of the inventive concept is not limited by these effects.

### DESCRIPTION OF THE DRAWINGS

FIG. 1A is a perspective view of an unmanned vehicle according to an embodiment.

FIG. 1B is a plan view of the unmanned vehicle illustrated in FIG. 1A.

FIG. 1C is a front view of the unmanned vehicle illustrated in FIG. 1A.

FIG. 2 is an enlarged view of a portion A of FIG. 1A.

FIG. 3A is a perspective view of another location of the unmanned vehicle of FIG. 1A.

FIG. 3B is a side view of the unmanned vehicle illustrated in FIG. 3A.

FIG. 4A is a perspective view of an unmanned vehicle according to another embodiment.

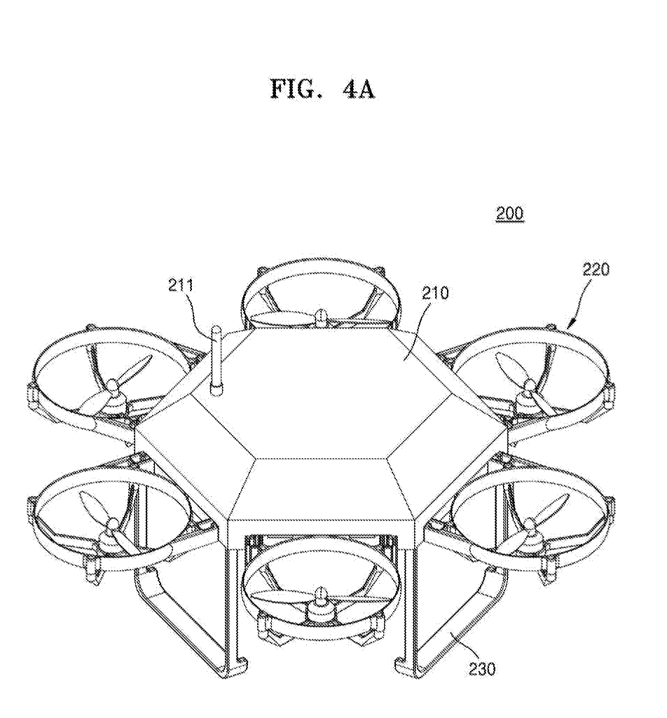

FIG. 4B is a perspective view of another location of the unmanned vehicle of FIG. 4A.

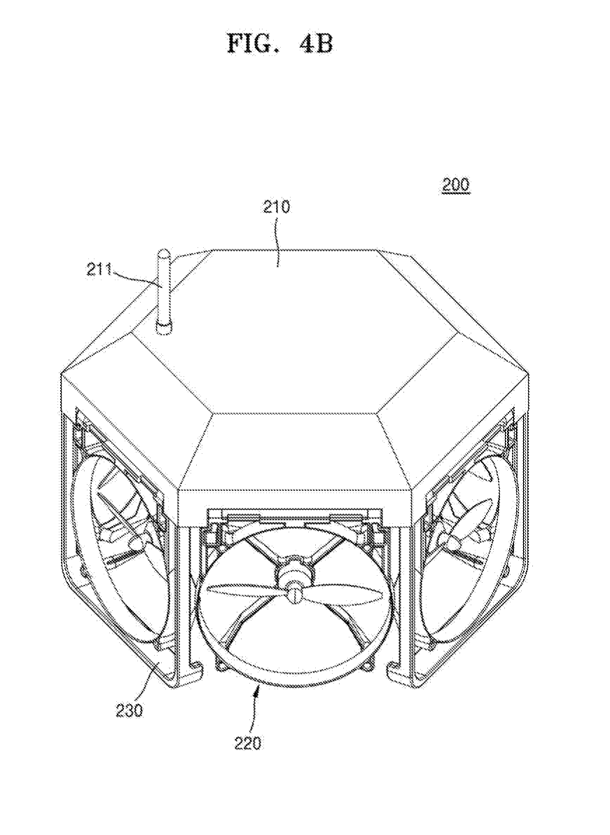

### BEST MODE

According to an aspect of the inventive concept, there is provided an unmanned vehicle including: a base; a driving unit including an actuator and a propeller rotating by using power of the actuator, the driving unit being provided outside the base capable of pivoting with respect to the base; and a supporter protruding from the base and supporting the base.

Also, the driving unit may be provided as a plurality of driving units and may be arranged in a radial form from a center of the base.

Also, the driving unit may pivot between a first location at which the driving unit is unfolded to form a same plane as that of the base, and a second location at which at least a portion of the driving unit is inserted between the supporters.

Also, when the driving unit is arranged at the second location, the base and the driving unit may form an inner space, and the propeller may be arranged in the inner space.

Also, the supporter may include a pair of first supporters connected to the base, and a second supporter connected to the first supporters and thicker than the first supporters.

The base may be formed in a circular form or a polygonal form, and the driving unit may be arranged on each surface of the base.

According to another aspect of the inventive concept, there is provided an unmanned vehicle including: a base; and a plurality of driving units including an actuator and a propeller rotating by using power of the actuator, the plurality of driving units being provided outside the base capable of pivoting with respect to the base, wherein the plurality of driving units and the base respectively form surfaces of a three-dimensional figure when at least one of the plurality of driving units rotates such that an angle between the at least one of the plurality of driving units and the base has a predetermined angle.

The unmanned vehicle may further include a supporter protruding from the base and supporting the base.

The driving unit may be arranged in a radial form from a center of the base.

According to further another aspect of the inventive concept, there is provided an unmanned vehicle including: a base; a plurality of driving units including an actuator and a propeller rotating by using power of the actuator, the plurality of driving units being provided, outside the base, in a radial form from a center of the base capable of pivoting with respect to the base.

### MODE OF THE INVENTION

The inventive concept will be apparent with reference to embodiments below together with the accompanying drawings. However, the inventive concept is not limited to the embodiments below but may be implemented in various forms. The embodiments are provided to allow a person of ordinary skill in the art to completely understand the scope of the inventive concept and make the disclosure of the inventive concept complete. The inventive concept may merely be defined by claims. Meanwhile, terms used in the specification are intended for describing embodiments and not for limiting the inventive concept. In the specification, the singular forms “a,” “an” and “the” are intended to include the plural forms as well, unless the context clearly indicates otherwise. It will be further understood that the terms “comprises” and/or “comprising” used herein specify the presence of stated components, operations, and/or devices but do not preclude the presence or addition of one or more other components, operations, and/or devices. It will be understood that although the terms “first”, “second”, etc. may be used herein to describe various components, these components should not be limited by these terms. These components are only used to distinguish one component from another.

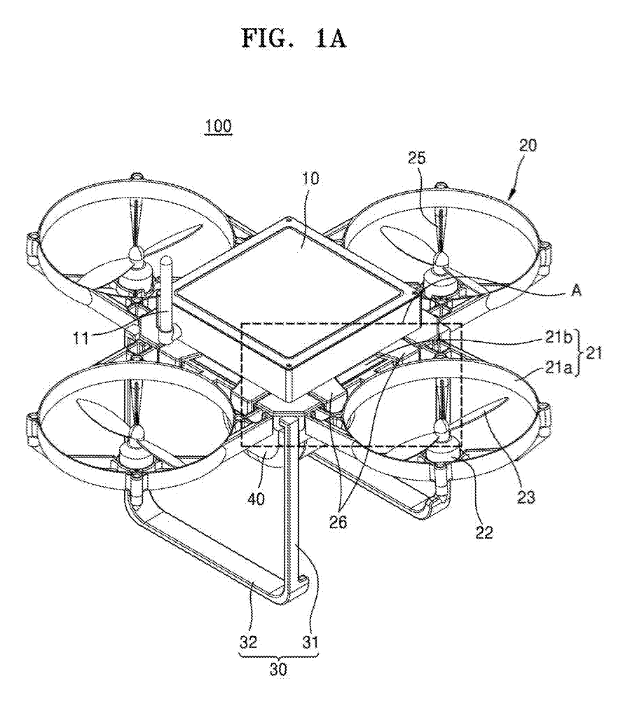

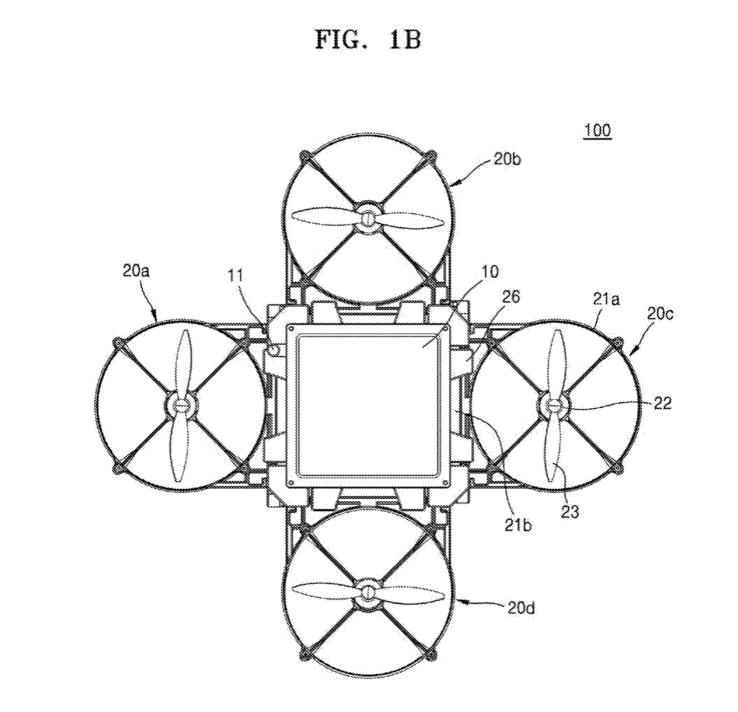

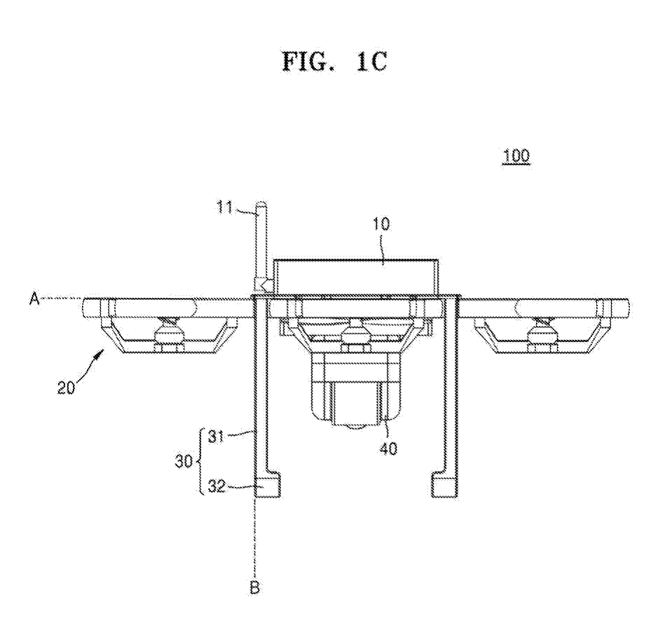

FIG. 1A is a perspective view of an unmanned vehicle 100 according to an embodiment, FIG. 1B is a plan view of the unmanned vehicle 100 illustrated in FIG. 1A, and FIG. 1C is a front view of the unmanned vehicle 100 illustrated in FIG. 1A.

Referring to FIGS. 1A to 1C, the unmanned vehicle 100 may include a base 10, a driving unit 20, and a supporter 30.

The base 10 may be arranged at the center of the unmanned vehicle 100 and form a center of balance of the unmanned vehicle 100. The base 10 provides a space in which a communication part, a control part, or an image capturing part, etc. mounted in the unmanned vehicle 100 may be provided.

The base 10 may support the driving unit 20 generating driving force in the unmanned vehicle 100. The driving unit 20 may be provided outside the base 10. The driving unit 20 is unfolded in a radial form from the center of the base 10. When the driving unit 20 generates driving force, an amount of air passing through the driving unit 20 may increase.

The base 10 is not limited to a specific form and may have a polyhedral form or a cylindrical form. However, for convenience of description, a case where the base 10 has a square pillar shape is mainly described.

The driving unit 20 may be rotatably mounted along lateral surfaces of the base 10. The base 10 has four lateral surfaces, and a first driving unit 20a, a second driving unit 20b, a third driving unit 20c, and a fourth driving unit 20d may be respectively mounted along the lateral surfaces of the base 10 (see FIG. 1B).

A control unit (not shown) may be provided in an inner space of the base 10. The control unit may include a sensor for manipulating a flight of the unmanned vehicle 100 or various sensors for aerial observation and control the sensors.

For example, the control unit may include a gyro sensor, an acceleration sensor, a location sensor, or a pressure sensor. The gyro sensor may measure a rotational velocity of the rotating unmanned vehicle 100 by measuring angular acceleration of the unmanned vehicle 100. The acceleration sensor may measure a movement velocity of the unmanned vehicle 100 by measuring acceleration of the unmanned vehicle 100. The location sensor may measure a location of the unmanned vehicle 100 by measuring a location coordinate of the unmanned vehicle 100. The pressure sensor may measure an altitude of the unmanned vehicle 100 by measuring external atmospheric pressure of the unmanned vehicle 100.

The control unit may receive signals input via a communication unit 11 and control a location, a velocity, or an altitude, etc. of the unmanned vehicle 100. The communication unit 11 may receive signals for location information (global positioning system (GPS) information) from an external controller (not shown) and transmit the signals for the location information to the control unit. Then, the control unit may control a location, a velocity, or an altitude, etc. of the unmanned vehicle 100 by adjusting a rotational velocity of an actuator 22.

Also, the control unit may generate information for a location, a velocity, or an altitude measured by the unmanned vehicle 100 as signals and transfer the signals to the communication unit 11. The communication unit 11 may transmit the transferred signals to the controller.

A camera module 40 is provided to the unmanned vehicle 100. The unmanned vehicle 100 may capture an aero photo or moving picture and collect an image or moving picture information. The camera module 40 may be mounted on one surface of the base 10 and may store an image or moving picture captured by the camera module 40 or transmit the image or moving picture to the controller via the communication unit 11.

A speaker module (not shown) or a microphone module (not shown) may be provided to the unmanned vehicle 100 and may emit or collect voice information.

The driving unit 20 may be rotatably provided to the base 10. The driving unit 20 may be mounted in a radial form from a center of the base 10. The driving unit 20 may generate driving force that drives the unmanned vehicle 100 and include a duct 21, the actuator 22, and a propeller 23.

The driving unit 20 may rotate and form a predetermined angle with the base 10, and thus the driving unit 20 and the base 10 may form each surface of a three-dimensional figure. An angle between the driving unit 20 and the base 10 is not limited to a specific angle and may be set depending on a user's selection. For example, when an angle between the driving unit 20 and the base 10 is 90 degrees and four driving units 20 are provided, the unmanned vehicle 100 may have approximately a cubic shape or a hexahedral shape.

The driving unit 20 may be provided as one or more driving units and arranged on a lateral surface of the base 10. However, for convenience of description, a case where four driving units 20 are mounted on lateral surfaces of the base 10 in the unmanned vehicle 100 is mainly described.

The duct 21 may be rotatably provided on a lateral surface of the base 10. The duct 21 may include an O-ring 21a provided outside the propeller 23 and a frame 21b contacting the base 10.

The O-ring 21a may be connected to the frame 21b and surround an outer surface of the propeller 23. The O-ring 21a may guide flowing of air passing through the propeller 23. The O-ring 21a may guide flowing of air in an axial direction of the propeller 23.

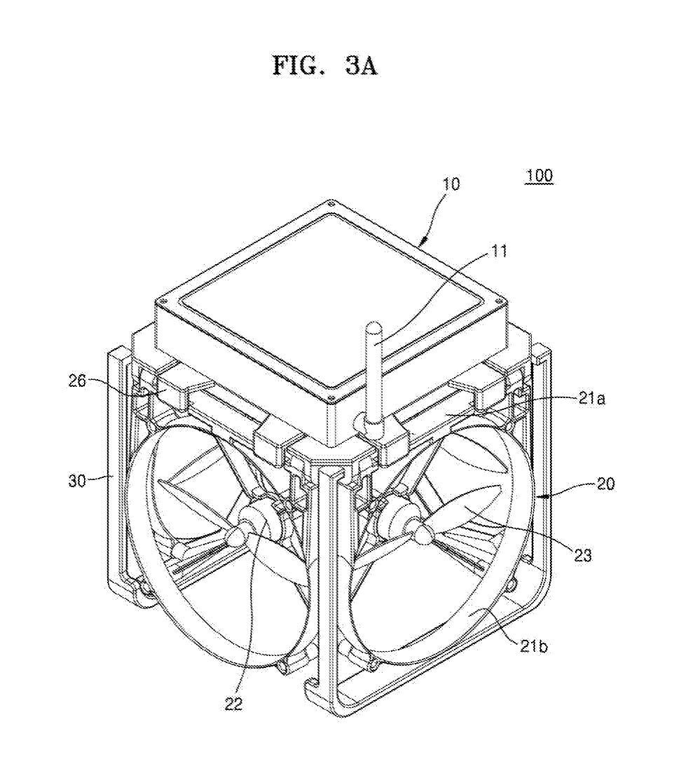

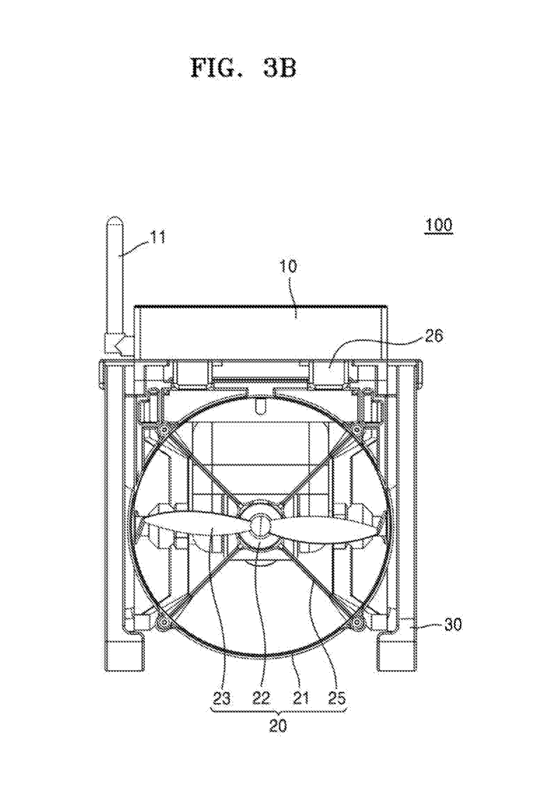

The frame 21b may be connected to the base 10 and rotate. A method in which the frame 21b rotates and elements of the frame 21b are not limited to a specific method or elements. For example, a piston and a cylinder may be connected to the frame 21b and the base 10, and the duct 21 may be rotated by linear motions of the piston and the cylinder. An actuator unit 41 may be provided to the base 10, and the duct 21 may be rotated by using driving force generated by the actuator unit 41. A spring may be provided between the base 10 and the frame 21b, and elastic force of the spring may maintain the duct 21 unfolded on the base 10. Also, the base 10 and the frame 21b may form hinge coupling, and the duct 21 may rotate by a predetermined angle. However, for convenience of description, a case where the duct 21 rotates through cooperation of the actuator unit 41 provided to the base 10 and a shaft 42 provided to the frame 21b is mainly described below (see FIG. 3).

The actuator 22 may generate driving force by rotating the propeller 23. The actuator 22 may be supported by a plurality of ribs 25 crossing the O-ring 21a. The actuator 22 may be controlled independently by the control unit. The actuator 22 may adjust driving force by adjusting revolution per minute (rpm) in response to a signal of the control unit. The actuator 22 may receive power from a battery (not shown) provided to the base 10 and transfer the power to the propeller 23.

The supporter 30 may protrude from the base 10 and support the base 10. The supporter 30 extends from one surface of the base 10. When the unmanned vehicle 100 is provided, the supporter 30 may support the base 10 by contacting the ground.

The supporter 30 may be provided as a plurality of supporters. The supporter 30 may maintain balance of the unmanned vehicle 100 by distributing weight of the base 10. The supporters 30 may respectively correspond to lateral surfaces of the base 10. However, for convenience of description, a case where two supporters 30 are respectively provided on opposite lateral surfaces of the base 10 to face each other is mainly described below.

The supporter 30 may include a pair of connected first supporters 31 crossing the base 10, and a second supporter 32 connecting the first supporters 31. The first supporters 31 may maintain an interval between the base 10 and the ground. The second supporter 32 may improve strength and balance of the supporter 30 by connecting the first supporters 31.

The second supporter 32 may be thicker than the first supporters 31. The second supporter 32 may protrude inward and increase an area contacting the ground. When a contact area between the unmanned vehicle 100 and the ground increases, stability of the unmanned vehicle may be increased.

An angle between the supporter 30 and the base 10 is not limited to a specific angle. For example, the base 10 may be substantially perpendicular to the first supporter 31, or an angle between the base 10 and the first supporter 31 may be an obtuse angle. However, a case where the base 10 is substantially perpendicular to the first supporter 31, and when the driving unit 20 is folded, the unmanned vehicle 100 approximately forms a hexahedron is mainly described below.

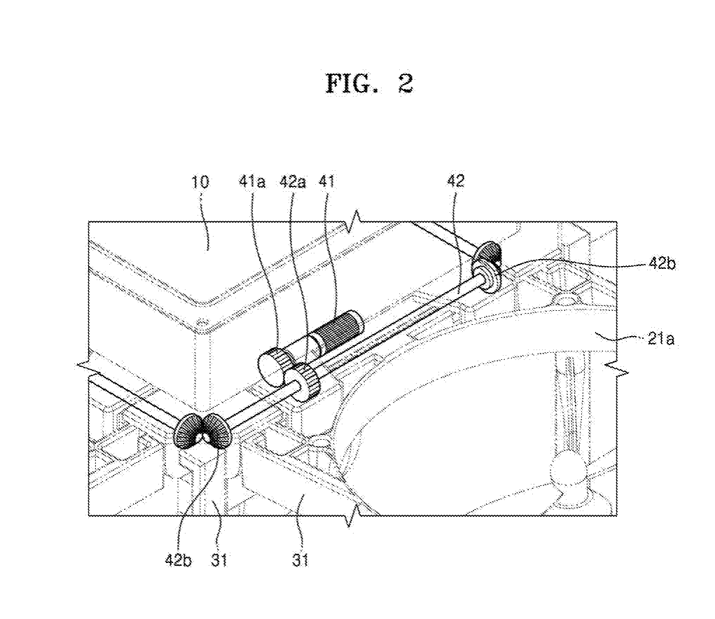

FIG. 2 is an enlarged view of a portion A of FIG. 1A.

Referring to FIG. 2, a method of operating the rotating driving unit 20 is described.

The actuator unit 41 may be provided in an inner space of the base 10. The actuator unit 41 may receive power from a battery (not shown) provided to the base 10. The number of actuator units 41 is not limited to a specific number. For example, a plurality of actuator units 41 may be arranged to correspond to the number of driving units 20. Also, the number of actuator units 41 less than the number of driving units 20 may be arranged and one actuator unit 41 may rotate a plurality of driving units 20. However, for convenience of description, a case where one actuator unit 41 rotates a plurality of driving units 20 is mainly described below.

A shaft 42 may be provided inside the frame 21b. The shaft 42 may rotate by receiving driving force from the actuator unit 41.

The shaft 42 may be provided to the frame 21b of each driving unit 20 to correspond to the driving unit 20. The shaft 42 may include a first connector 42a cooperating with a power transfer unit 41a of the actuator unit 41, and second connectors 42b provided to its opposite ends.

Though the power transfer unit 41a of the actuator unit 41 is shown to be connected to the first connector 42a via gear coupling, the connection is not limited thereto and may be changed to a belt or a pulley.

The second connector 42b includes a bevel gear and may be connected to a second connector of adjacent another shaft. The driving unit 20 and another driving unit adjacent to the driving unit 20 may form a predetermined angle.

For one actuator unit 41 to simultaneously rotate a plurality of driving units 20, a plurality of shafts 42 should be connected such that the shafts 42 may cooperate with each other. Opposite ends of the shaft 42 include a bevel gear and are arranged to have a predetermined angle such that the shaft 42 corresponds to adjacent other shafts and adjacent other driving units. The shaft 42 may receive power from the actuator unit 41 and transfer the power to adjacent another shaft. When the actuator unit 41 is driven, a plurality of driving units 20 may rotate.

FIG. 3A is a perspective view of another location of the unmanned vehicle 100 of FIG. 1A, and FIG. 3B is a front view of the unmanned vehicle 100 illustrated in FIG. 3A.

Referring to FIGS. 1C, 3A, and 3B, an arrangement (a first location) of the unmanned vehicle during flight and an arrangement (a second location) of the unmanned vehicle during storage and transport may be respectively described through folding of the driving units 20. The driving unit 20 may pivot between the first location in which the driving unit 20 is unfolded to form a same plane as that of the base 10, and the second location in which the driving unit 20 is inserted between the supporters 30.

The plurality of driving units 20 may be unfolded to form a same plane and arranged at the first location. The plurality of driving units 20 may form a same plane as that of the base 10 to allow air passing through each propeller 23 to flow in one direction. That is, the driving unit 20 may be arranged such that air flows in a direction perpendicular to the base 10 and improve mobility of the unmanned vehicle 100 (see FIG. 1C).

The plurality of driving units 20 may be folded and be inserted into the supporter 30 and be arranged at the second location. The plurality of driving units 20 may be arranged to be perpendicular to the base 10. When the plurality of driving units 20 are arranged at the second location, the unmanned vehicle 100 may form a cubic shape or an approximate hexahedral shape. However, this is formed by the number of driving units 20. The unmanned vehicle 100 may form a shape such as a triangular prism, a pentagonal pillar, a hexagonal pillar, an octagonal pillar, or a cylinder depending on the number of driving units 20 (see FIGS. 3A and 3B).

When the unmanned vehicle 100 is arranged at the second location, the base 10 and the driving units 20 of the unmanned vehicle 100 may form an inner space. In this case, the actuator 22 and the propeller 23 may be arranged in the inner space. In detail, a front end of the propeller 23 may not protrude from the driving unit 20. Since the propeller 23 is manufactured solidly and sharply, when the propeller 23 protrudes to outside, a problem may occur in safety while the propeller 23 is stored and carried. When the propeller 23 is arranged at the second location, the propeller 23 does not protrude to outside.

Referring to FIG. 1C, the propeller 23 is arranged at a lower portion below a line A. The front end of the propeller 23 does not protrude to the line A. When the unmanned vehicle 100 is arranged at the second location, the driving unit 20 rotates such that the line A overlaps a line B. When the unmanned vehicle 100 is arranged at the second location, the propeller 23 and the actuator 22 are arranged in the right of the line B. Therefore, when the unmanned vehicle 100 is arranged at the second location, the propeller 23 and the actuator 22 do not protrude to outside.

Since the propeller 23 of the unmanned vehicle 100 does not protrude to outside, safety in storage may be increased. Also, since a size of the unmanned vehicle 100 is minimized, spatial utility may be increased and destruction of the propeller 23 may be reduced.

The second supporters 32 may protrude to the inner portion of the unmanned vehicle 100 while facing each other. When the second supporters 32 are arranged at the second location, a protruding portion of the second supporters 32 may be arranged in an inner space and thus minimize the size of the unmanned vehicle 100. Therefore, since the unmanned vehicle 100 may be easily stored, spatial utility of the unmanned vehicle 100 may be increased.

In the unmanned vehicle 100, the driving unit 20 may be arranged at the first location or the second location by manipulating the driving unit 20. Also, the unmanned vehicle 100 may change a location of the driving unit 20 by receiving driving force from the piston, a cylinder, and the actuator.

When the driving unit 20 is connected to the base 10 via hinge coupling, a fixing unit 26 may fix a location of the driving unit 20. The fixing unit 26 may have predetermined elasticity. The fixing unit 26 may fix a location of the driving unit 20 by surrounding one surface of the frame 21b. The frame 21b includes a quadrangular pillar shape, and the fixing unit 26 may support the driving unit 20 by supporting a surface of the pillar. Though the number of fixing units 26 is not limited to a specific number, a pair of fixing units 26 may be provided to each frame 21b.

When the driving unit 20 is arranged at the first location, the unmanned vehicle 100 may fly by using driving force of the driving unit 20. Also, the unmanned vehicle 100 may switch a direction or change an altitude by adjusting a rotational speed of the propeller 23 of each driving unit 20. Also, the unmanned vehicle 100 may perform hovering by maintaining a same speed of the propeller 23.

When the driving unit 20 is arranged at the second location, the unmanned vehicle 100 may be easily stored. Since the volume of the unmanned vehicle 100 is minimized, spatial utility may be improved.

FIG. 3A is a perspective view of another location of an unmanned vehicle 200 according to another embodiment, and FIG. 3B is a side view illustrating another location of the unmanned vehicle 200 of FIG. 3A.

Referring to FIGS. 3A and 3B, the unmanned vehicle 200 may include a base 210, a communication unit 211, a driving unit 220, and a supporter 230. However, other parts of the unmanned vehicle 200 are the same as that of the previous embodiment, the shape of the base 210 and the number of driving units 220 are different. Therefore, in describing the present embodiment, descriptions of the above-described unmanned vehicle 100 are referred to for the other parts which are not described herein, and descriptions thereof are omitted.

The base 210 may include a hexahedral pillar shape. Six driving units 220 may be respectively arranged along lateral surfaces of the base 210. That is, the driving units 220 may be arranged in a radial form from the center of the base 210.

The supporter 230 may protrude from one surface of the base 210. The supporter 230 may maintain an interval between the base 210 and the ground. The supporter 230 may be provided as a plurality of supporters respectively along lateral surfaces of the base 210. The supporters 230 may be arranged in a radial form from the center of the base 210 in order to distribute weight of the base 210.

The plurality of driving units 220 may be unfolded to form a same plane and the unmanned vehicle 200 may fly. Also, while the unmanned vehicle 200 is not in use, the plurality of driving units 220 may be folded and at least partially inserted to the supporter 230.

While flying, the unmanned vehicle 200 is driven with the driving units 220 unfolded, and while not flying, the unmanned vehicle 200 is stored with the driving units 220 folded. In the unmanned vehicle 200, a size of the driving unit 220 including the propeller is manufactured large in order to increase flux of air passing through the driving unit 220 and thus improve mobility. Since the unmanned vehicle 200 may fold the driving unit 220 when needed, storage and management of the unmanned vehicle 200 may be easily performed.

Although the inventive concept has been described with reference to the above-mentioned embodiments, various modifications or changes may be made without departing from the spirit and scope of the inventive concept. Therefore, these modifications or changes, as far as they belong to the spirit of the inventive concept, fall within the scope of appended claims.

### INDUSTRIAL APPLICABILITY

An embodiment provides an unmanned vehicle with improved spatial utility, and embodiments are applicable to all transporting apparatuses for military, emergency, and industrial purposes, and toys that include an unmanned vehicle for industrial use.

1. An unmanned vehicle comprising:
a base;
a driving unit comprising an actuator and a propeller rotating by using power of the actuator, the driving unit being provided outside the base capable of pivoting with respect to the base; and
a supporter protruding from the base and supporting the base.

2. The unmanned vehicle of claim 1, wherein the driving unit is provided as a plurality of driving units and is arranged in a radial form from a center of the base.

3. The unmanned vehicle of claim 1, wherein the driving unit rotates between a first location at which the driving unit is unfolded to form a same plane as that of the base, and a second location at which at least a portion of the driving unit is inserted between the supporters.

4. The unmanned vehicle of claim 3, wherein when the driving unit is arranged at the second location, the base and the driving unit form an inner space, and the propeller is arranged in the inner space.

5. The unmanned vehicle of claim 1, wherein the supporter comprises:
a pair of first supporters connected to the base; and
a second supporter connected to the first supporters and thicker than the first supporters.

6. The unmanned vehicle of claim 1, wherein the base is formed in a circular form or a polygonal form, and the driving unit is arranged on each surface of the base.

7. An unmanned vehicle comprising:
a base; and
a plurality of driving units comprising an actuator and a propeller rotating by using power of the actuator, the plurality of driving units being provided outside the base capable of pivoting with respect to the base,
wherein the plurality of driving units and the base respectively form surfaces of a three-dimensional figure when at least one of the plurality of driving units pivots such that an angle between the at least one of the plurality of driving units and the base has a predetermined angle.

8. The unmanned vehicle of claim 7, further comprising a supporter protruding from the base and supporting the base.

9. The unmanned vehicle of claim 7, wherein the driving unit is arranged in a radial form from a center of the base.

10. An unmanned vehicle comprising:
a base;
a plurality of driving units comprising an actuator and a propeller rotating by using power of the actuator, the plurality of driving units being provided, outside the base, in a radial form from a center of the base capable of pivoting with respect to the base.

11. An unmanned vehicle comprising:
a base;
a plurality of driving units comprising an actuator and a propeller rotating by using power of the actuator, the plurality of driving units being provided outside the base capable of pivoting with respect to the base;
an actuator unit provided to the base and simultaneously rotating the plurality of driving units; and
a supporter protruding from the base and supporting the base.

12. The unmanned vehicle of claim 11, wherein the driving unit pivots between a first location at which the driving unit is unfolded to form a same plane as that of the base, and a second location at which the plurality of the driving units are inserted between the supporters.

13. The unmanned vehicle of claim 11, wherein the supporter comprises:
a pair of first supporters connected to the base; and
a second supporter connected to the first supporters and thicker than the first supporters.
